(19) United States
(12) Patent Application Publication
(10) Pub. No.: US 2026/0147136 A1
(43) Pub. Date: May 28, 2026

(54) MODULAR COUPLED WATER-HEAT HYDROLOGICAL MODEL OF DISTRIBUTED COLD REGION

(71) Applicant: Sichuan University, Chengdu (CN)

(72) Inventors: Genxu WANG, Chengdu (CN); Linmao GUO, Chengdu (CN); Chunlin SONG, Chengdu (CN); Shouqin SUN, Chengdu (CN); Xiangyang SUN, Chengdu (CN)

(73) Assignee: Sichuan University, Chengdu (CN)

(21) Appl. No.: 19/452,187

(22) Filed: Jan. 16, 2026

(30) Foreign Application Priority Data
Jan. 17, 2025 (CN) 202510076750.5

(51) Int. Cl. G01V 20/00; G06F 30/28; G06F 111/10; G06F 113/08

(52) U.S. Cl. CPC G01V 20/00; G06F 30/28; G06F 2111/10; G06F 2113/08

(57) ABSTRACT

A construction method for a modular coupled water-heat hydrological model of distributed cold regions is provided, and includes: S1, dividing a basin into multiple grids, and preparing documents required for a flow concentration process; S2, preparing driving data and grid feature description data of each of the grids; S3, calculating an energy balance process of soil and vegetation surface by using the energy balance module; S4, calculating an evapotranspiration process by using the evapotranspiration module; S5, calculating an ice-snow melting process by adopting a degree-day factor method by using the ice-snow melting module; S6, calculating soil moisture infiltration and an internal water-heat transmission process by using the soil water-heat transmission and infiltration module; S7, calculating a runoff amount by using the runoff generation calculation and concentration module; and S8, evaluating simulation performance of the model by model evaluation indicators.

### CROSS-REFERENCE TO RELATED APPLICATIONS

This application claims priority of Chinese Patent Application No. 202510076750.5, filed on Jan. 17, 2025, the content of which is hereby incorporated by reference.

### TECHNICAL FIELD

The disclosure relates to the technical field of permafrost hydrology and watershed runoff production, and in particular to a modular coupled water-heat hydrological model of distributed cold regions.

### BACKGROUND

Permafrost, as a special regional “aquitard” or “weak permeable layer”, has obviously low hydraulic conductivity, which weakens or hinders the hydraulic connection among precipitation, surface water and groundwater on a certain time-space scale, and strongly affects the runoff production process of surface runoff and the migration and distribution pattern of underground runoff Under the background of climate change, permafrost degradation will have a far-reaching impact on regional hydrological conditions, including changes in soil moisture, seasonal characteristics of runoff, and changes in the distribution of surface and groundwater reserves. Therefore, under the background of accurately simulating and forecasting climate change, permafrost change and influence on hydrological processes are very important for downstream water resources management.

Traditional hydrological models often use some empirical formulas (such as Stefan equation, air temperature-hydraulic conductivity index relationship, etc.) to reflect the influence of permafrost on hydrological processes. Although this simple empirical method, which links air temperature with soil freeze-thaw cycle, improves the accuracy of runoff simulation in permafrost basin to some extent, it may not represent the mutual feedback of soil water and heat transmission process, and is not suitable for studying the interaction between permafrost and hydrological process changes and permafrost degradation and hydrological process under changing environment. Process-based hydrological models in cold regions, such as VIC, GBEHM, WEB-DHM-pf, often require high input data, and the application in the Tibetan Plateau where data are scarce also has certain limitations. In addition, most process-based models are designed with specific problem-oriented or goal-oriented methods, relying on a single mathematical theoretical basis, unique parametric schemes and fixed data requirements. This greatly limits the applicability of the model and simulation/prediction ability under the actual modeling conditions.

### SUMMARY

In order to solve the above problems, the disclosure provides a modular coupled water-heat hydrological model of distributed cold regions to solve the above problems.

The disclosure provides a construction method for a modular coupled water-heat hydrological model of distributed cold regions, the model includes an energy balance module, an evapotranspiration module, an ice-snow melting module, a soil water-heat transmission and infiltration module, and a runoff generation calculation and flow concentration module, where the method includes:
S1, according to elevation data and basin outlet positions, extracting a basin range by GIS software, dividing a basin into multiple grids, and preparing documents required for a flow concentration process, such as flow direction data, grid spherical distance and grid area ratio (the ratio of internal grids in the basin is 1, and the ratio of boundary grids in the basin is less than 1);
S2, preparing driving data (air temperature, precipitation, wind speed, relative humidity, incident short-wave radiation, incident long-wave radiation, leaf area index, etc.) and grid feature description data (altitude, soil layer thickness, soil texture, organic matter content, etc.) of each of the grids;
S3, calculating an energy balance process of soil and vegetation surface by using the energy balance module;
S4, calculating an evapotranspiration process by using the evapotranspiration module;
S5, calculating an ice-snow melting process by adopting a degree-day factor method by using the ice-snow melting module;
S6, calculating soil moisture infiltration and an internal water-heat transmission process by using the soil water-heat transmission and infiltration module;
S7, calculating a runoff amount by using the runoff generation calculation and concentration module; and
S8, evaluating simulation performance of the model by model evaluation indicators.

Preferably, where the S3 includes:
calculating net shortwave radiation:

$$\begin{matrix}N {s}_{v e g} = {R}_{s} * FVC * [ ( 1 - {α}_{c} ) + {τ}_{c} * ( {α}_{soil / snow} - 1 ) ] ; \\ {Ns}_{soil / snow} = {R}_{s} * ( 1 - {α}_{soil / snow} ) * [ ( 1 - F V C ) + {τ}_{c} * FVC ] ;\end{matrix}$$

where, Ns_{veg} is net short-wave radiation absorbed by the vegetation surface, Ns_{soil/snow} is net short-wave radiation absorbed by bare soil or snow surface, Rₛ is incident short-wave radiation, τ_{c} is a proportion of short-wave radiation transmitted by vegetation, α_{c} is an albedo of vegetation surface, α_{soil/snow} is an albedo of the bare soil or snow surfaces, and FVC is vegetation coverage;
calculating net long-wave radiation:

$$N {l}_{v e g} = FVC * [ {L}_{d} + {L}_{soil / snow} - 2 * {L}_{c} ] ; {Nl}_{soil / snow} = ( 1 - F VC ) * {L}_{d} + FVC * {L}_{c} - {L}_{soil / snow} ] ;$$

where, Nl_{veg} is net long-wave radiation absorbed by the vegetation surface, Nl_{soil/snow} is net long-wave radiation absorbed by the bare soil or snow surface, L_{c} is long-wave radiation emitted by canopy surface, L_{d} is incident long-wave radiation, and L_{soil/snow} is long-wave radiation emitted by the bare soil or snow surface;
where, surface net radiation is equal to a sum of net short-wave radiation and net long-wave radiation:

$${R}_{n e t} = N s + {N}_{l} ;$$

where, Ns is net short-wave radiation, and Nₗ is net long-wave radiation;
a calculation formula of surface heat flux is:

$${G}_{0} = 0 \text{.35462} * {R}_{n e t} - 47.79008 ;$$

where, G₀ is the surface heat flux.

Preferably, the S4 includes the following steps.

The etotal evapotranspiration (Etotal) of each grid consists of three parts: vegetation transpiration (Etrans), interception evaporation (Eint) and soil evaporation (Esoil). Based on the calculated energy balance of vegetation surface and bare soil surface, transpiration, interception evaporation and soil evaporation are calculated respectively. The root ratio of vegetation at different depths is calculated, the calculated transpiration is distributed to each layer of soil according to the root ratio, and the soil evaporation is distributed to the surface soil layer completely. The specific calculation process of each evaporation component is as follows:
calculating a potential evapotranspiration:

$${E}_{pot} = \frac{Δ * {Q}_{n e} + {ρ}_{a i r} {c}_{a i r} * ( {e}_{s} - {e}_{a} ) / {r}_{a}}{{ρ}_{l i q} {L}_{v} ( Δ + γ * ( 1 + {r}_{c} / {r}_{a} ) )} ;$$

where, Δ is a slope of a curve of saturated vapor pressure changing with temperature, Qₙₑ is available energy, and includes potential heat consumed by ice-water phase change, ρₐᵢᵣ is density of air, cₐᵢᵣ is specific heat of air, eₛ is saturated vapor pressure, eₐ is actual vapor pressure, rₐ is aerodynamic impedance, r_{c} is canopy impedance, γ is a hygrometer constant, ρ_{liq} is density of liquid water, and L, is vaporization potential heat;
calculating interception evaporation on the canopy surface:

$${E}_{int} = {( \frac{{Int}_{sto}}{{Max}_{it}} )}^{2 / 3} * {E}_{pot} * Δ t * min ( 1 , * \frac{{( {Int}_{sto} * {Max}_{it}^{2} )}^{1 / 3}}{{E}_{pot} * Δ t} ) ;$$

where, Intₛₜₒ is interception water output, Maxᵢₜ is a maximum interception water storage capacity, and Δt is a time step;
calculating transpiration of the canopy surface:

$$\begin{matrix}{f}_{d r y} = 1 - f * {( \frac{{Int}_{sto}}{{Max}_{it}} )}^{2 / 3} ; \\ {E}_{t r a n s} = {E}_{pot} * {f}_{dry} * {root}_{frac , i} * Δ t ;\end{matrix}$$

where, f_{dry} is a dry ratio of the canopy surface, Eₜᵣₐₙₛ is the transpiration of the canopy surface, and root_{frac,i} is a root ratio in an i-th layer soil layer;
calculating soil evaporation:

$${E}_{soil} = min ( {E}_{pot} * Δ t , {( \frac{8 * {η}_{1} * {K}_{sat} * ( - {Ψ}_{e} )}{3 ( 1 + 3 m ) ( 1 + 4 m )} )}^{1 / 2} * {( \frac{{θ}_{1}}{{η}_{1}} )}^{1 / 2} {( Δ t )}^{\frac{1}{2}} ) ;$$

where, θ₁ is liquid water content of surface soil, η₁ is a porosity of the surface soil, Kₛₐₜ is a saturated hydraulic conductivity of the soil, m is a reciprocal of Campbell pore size distribution index, and Ψₑ is air entry potential.

Preferably, where the S5 includes:
calculating a snow melting process by a following formula:

$${M}_{s n o w} = \{ \begin{matrix}DD {F}_{s n o w} * ( {T}_{a i r} - {T}_{s n o w} ) + S R {F}_{s n o w} * N {s}_{s n o w} {T}_{a i r} > {T}_{s n o w} \\ 0 {T}_{a i r} \leq {T}_{s n o w}\end{matrix} ;$$

where, M_{snow} is a snow melting amount, DDF_{snow} is a snow melting degree-day factor, SRF_{snow} is a short-wave radiation factor, Ns_{snow} is a snow melting surface net short-wave radiation, Tₐᵢᵣ is air temperature, and T_{snow} represents a highest temperature threshold value when precipitation is snowfall;
where combining a glacier zone method with a degree-day factor method and an area volume-ratio method to simulate a glacier runoff process includes:
dividing each glacier into multiple glacier zones, interpolating air temperature and precipitation data of each of the glacier zones, and calculating an area ratio of each of the glacier zones in each of the grids;
dividing rain and snow based on the air temperature and precipitation data of each of the glacier zones obtained by interpolation, obtaining a rainfall amount and a snowfall amount of each of the glacier zones, and calculating a snow water equivalent amount of each of the glacier zones;
when air temperature drops below a snow melting threshold temperature, calculating a potential snow melting amount by the degree-day factor method, and comparing with a snow water equivalent amount in a current glacier zone; if the potential snow melting amount is less than the snow water equivalent amount, only occurring the snow melting process, otherwise a underlying glacier begins to melt:

$${M}_{b a n d} \{ \begin{matrix}{M}_{snow , band} {SWE}_{band} \geq {M}_{snow , band} > 0 \\ {SWE}_{band} + [ {M}_{snow , band} - {SWE}_{band} ] * \frac{{DDF}_{ice}}{{DDF}_{snow}} \\ {DDF}_{ice} * ( {T}_{band} - {T}_{melt} ) {SWE}_{band} = 0\end{matrix} 0 < {SWE}_{b a n d} < {M}_{snow , band ;}$$

where, M_{band} represents total snow and glacier melting water, DDF_{ice} is a glacier melting degree-day factor, SWE_{band} is snow water equivalent amount of the current glacier zone, M_{snow,band} is the potential snow melting amount, T_{band} is air temperature of the glacier zone, and Tₘₑₗₜ is a melting temperature of snow or glacier;
where a runoff depth of each of the glacier zones is equal to a sum of a rainfall amount and a total melting water of snow and ice; on scale of each of the grids, a runoff depth of a glacier area is equal to a sum of products of all glacier zone runoff generation amounts and an area ratio contained in the grid:

$$\begin{matrix}{R}_{band , i} = {P}_{rain , band , i} + {M}_{band , i} ; \\ {R}_{glacier} = {\sum }_{i = 1}^{n} {A}_{frac , i} * {R}_{band , i} ;\end{matrix}$$

where, i is a number of each of the glacier zones, n is a number of the glacier zones, R_{band,i} is a runoff depth of an i-th glacier zone, R_{glacier} is a runoff depth of the glacier area, P_{rain,band,i} is a rainfall amount of the i-th glacier zone, M_{band,i} is an ice and snow melting water amount of the i-th glacier zone, and A_{frac,i} is an area proportion of the i-th glacier zone in the grid.

Preferably, where the S6 adopts multi-layer soil structure to reflect a water-heat transmission process in soil, and dividing soil thickness is determined by an exponential stratification method; in each time step, a calculation process of the water-heat transmission process in a soil layer includes:
S61, calculating hydrothermal parameters of soil based on current soil liquid water content, ice content and organic matter content, where the hydrothermal parameters include thermal conductivity, hydraulic conductivity, volumetric heat capacity and moisture flux;
S62, solving a heat transmission equation to obtain a temperature of each layer of soil;
S63, updating soil liquid water content and ice content, hydraulic conductivity and moisture flux based on a latest calculated soil temperature;
S64, solving a Richard equation of considering ice-water phase transition to obtain water content and ice content of each layer of soil;
S65, repeating S61-S64, until errors of soil temperature and soil moisture reach a convergence standard; and
S66, calculating a water infiltration process by a multi-layer Green-Ampt algorithm, and updating soil moisture and soil temperature.

Preferably, where the water-heat transmission process in the soil layer is calculated by a following formula:
for each layer of soil, calculating a change of soil temperature:

$${C}_{s} \frac{\partial T}{\partial t} - {L}_{f} {ρ}_{i c e} \frac{\partial {θ}_{i c e}}{\partial t} = \frac{\partial }{\partial z} [ {λ}_{s} \frac{\partial T}{\partial z} ] - {C}_{l i q} \frac{\partial {q}_{l} T}{\partial z} ;$$

where, Cₛ is volumetric heat capacity of soil, λₛ is a thermal conductivity of the soil, ρ_{ice} is density of ice, θ_{ice} is a volumetric ice content, qₗ is a liquid moisture flux, C_{liq} is volumetric heat capacity of liquid water, T is a temperature of the soil, Z is a depth of the soil, and L_{f} is melting potential;
the volumetric heat capacity of the soil is expressed as a weighted sum of volumetric heat capacities of various components in the soil:

$${C}_{s} = ( 1 - organic ) * {ρ}_{b} * {c}_{m} + organic * {ρ}_{b} * {c}_{o} + {θ}_{liq} * {ρ}_{liq} * {c}_{liq} + {θ}_{i c e} * {ρ}_{i c e} * {c}_{i c e} + {θ}_{air} * {ρ}_{air} * {c}_{air} ;$$

where, ρ_{b} is soil bulk density, cₘ is specific heat of minerals, cₒ is specific heat of organic matter, θₐᵢᵣ is volume fraction of air, θ_{liq} is a water content of liquid water (m³·m₋₃), and organic is volume fraction of the organic matter;
the thermal conductivity of the soil is obtained by combining dry state thermal conductivity and saturated state thermal conductivity weighted by Kersten number:

$${λ}_{s} = ( {λ}_{s a t} - {λ}_{d r y} ) * {K}_{e} + {λ}_{d r y} ;$$

where, Kₑ is a function of soil saturation and the volume fraction of the organic matter, λ_{dry} is soil dry state thermal conductivity, and λₛₐₜ is soil saturated state thermal conductivity;

$${K}_{e} = \{ \begin{matrix}{S}_{r}^{( 1 + organic - {av}_{sand} - {v}_{gravet} ) {\{ {[ \frac{1}{1 + {e}^{- β {s}_{r}}} ]}^{3} - {( \frac{1 - {S}_{r}}{2} )}^{3} \}}^{1 - organic} unfreezed soil} \\ {S}_{r}^{1 + organic} frozen soil\end{matrix} ;$$

where, Sᵣ is the soil saturation, v_{sand} is volume fraction of sand, v_{gravel} is volume fraction of gravel, and α and β are adjustment factors; a relationship between Kₑ and Sᵣ is used to predict a continuous change of thermal conductivity in a whole soil saturation level and particle size distribution range, enabling to be suitable for a calculation of thermal conductivity of permafrost in arid and semi-arid areas;
in cold areas, when soil temperature is higher than a freezing point, matrix potential is expressed as a function of liquid water content, and when temperature drops below the freezing point, the matrix potential drops rapidly, and is given by a freezing point water potential equation:

$$Ψ = \{ \begin{matrix}\frac{{L}_{f} \cdot T}{g * ( T + 237.15 )} T \leq {T}_{f} \\ {Ψ}_{e} * {( \frac{{θ}_{l i q}}{{θ}_{s a 𝔱}} )}^{- b} T > {T}_{f}\end{matrix} ;$$

where, Ψ is soil matrix potential, b is Campbell pore size distribution index, T_{f} is the freezing point, θₛₐₜ is saturated water content, and g is gravity acceleration;
describing a moisture movement by using matrix potential gradient;

$${q}_{l} = {K}_{eff} \cdot ( \frac{\partial Ψ}{\partial z} + 1 ) ;$$

where, K_{eff} is effective hydraulic conductivity;
when the soil begins to freeze, blocking effect of soil ice on moisture transmission is considered by introducing a blocking factor:

$${K}_{eff} = \{ \begin{matrix}{K}_{sat} * {( \frac{Ψ}{{Ψ}_{e}} )}^{( 2 + 3 / b )} {θ}_{ice} = 0 \\ {K}_{sat} * {( \frac{Ψ}{{Ψ}_{e}} )}^{( 2 + 3 / b )} * {10}^{- E * {m}_{ice}} {θ}_{ice} > 0\end{matrix} ; {m}_{i c e} = \frac{{ρ}_{i c e} * {θ}_{i c e}}{{ρ}_{i c e} * {θ}_{i c e} + {ρ}_{l i q} * {θ}_{l i q}} ;$$

where, E is the blocking factor, and m_{ice} is a ratio of ice content to total water content;
assuming that the soil medium is incompressible, and water vapor migration is ignored, according to Darcy's law and mass conservation principle, obtaining a basic equation of soil moisture movement:

$$\frac{\partial {θ}_{l i q}}{\partial t} = \frac{\partial }{\partial z} [ {K}_{eff} ( \frac{\partial Ψ}{\partial z} + 1 ) ] - \frac{{ρ}_{i c e}}{{ρ}_{l i q}} \frac{\partial {θ}_{i c e}}{\partial t} + S ;$$

where S is source sink term in the water flux.

Preferably, where S7 includes:
S71, calculating surface runoff depth and underground runoff depth of each of the grids.

Melting snow and rain piercing through the forest are the sources of infiltration moisture. The surface water reserve is equal to the difference between the sum of the rain piercing through the forest and the melting snow amount and the total accumulated infiltration. The surface runoff is calculated by the following formula:

$${R}_{s u r} = max ( \text{} 0 , [ ( {P}_{rain} + {M}_{s n o w} ) - Infil - {Pond}_{m ax} ] * ( 1 - {glacier}_{frac} ) + {glacier}_{frac} * {R}_{glacier} ) ;$$

where, Pᵣₐᵢₙ is rainfall amount of the grid, Pondₘₐₓ is a maximum allowable water depth, Infil is a total accumulated water seepage amount, and glacier_{frac} is a proportion of glacier area in the grid.

In the process of soil freezing and melting, the freezing front or melting front will temporarily act as a water-resisting layer, which makes it difficult to distinguish the frozen layer groundwater and the interflow of soil. Therefore, underground runoff is used to describe the process of underground runoff production; underground runoff of an i-th layer soil is:

$${R}_{s u b , i} = \{ \begin{matrix}( {θ}_{l i q} - {θ}_{f} ) * Δ {z}_{i} / Δ t * {α}_{r} * Δ t & {θ}_{l i q} > {θ}_{f} \\ 0 & {θ}_{l i q} \leq {θ}_{f}\end{matrix} ;$$

where, θ_{f} is a field capacity, Δzᵢ is a thickness of the i-th layer soil, and αᵣ is an underground runoff factor (-);
a total underground runoff is a sum of R_{sub,i} of all soil layers above bedrock.
S72, calculating a confluence process.

Based on a confluence file prepared the elevation data, driven by simulated output surface runoff depth and underground runoff depth, and calculating a process of slope surface confluence and river network confluence by a Lohmann confluence model, obtaining basin outlet runoff, in the cold season, the river flow in the permafrost basin is mainly maintained by frozen layer groundwater, and Q90 in the flow duration curve is used to represent frozen layer groundwater. Based on the runoff variation characteristics of many rivers in the permafrost regions of Siberia and Tibetan Plateau in recent decades, building an empirical relationship between annual average air temperature, annual average precipitation, permafrost coverage rate and frozen layer groundwater:

$${Q}_{subper} = δ + {β}_{1} \overline{T} + {β}_{2} \overline{P} + {β}_{3} \overline{{Per}_{c o v e r}} ;$$

Where, δ, β₁, β₂ and β₃ are fitting parameters, T̅ is the multi-year moving average of air temperature (° C.), P̅ is the multi-year moving average of precipitation (mm), and P̅e̅r̅_̅{̅c̅o̅v̅e̅r̅}̅ is the multi-year moving average of permafrost coverage (%). Lohmann confluence model is used to calculate the confluence process, and the daily surface runoff depth and underground runoff depth are used to drive Lohmann confluence model to calculate the process between slope surface confluence and river network confluence. Lohmann confluence model converges runoff to the outlet of a given grid, and then adds it to the river network confluence model that couples all grids together. By solving the linear Saint-Venant equation, the confluence process of river network is estimated to obtain the runoff at the outlet of the basin. final runoff at basin outlet is a sum of output of the Lohmann confluence model and output of a freezing layer groundwater module, namely:

$${Q}_{total} = {Q}_{s u {r}_{-} s u b} + {Q}_{subper} ;$$

where, Qₜₒₜₐₗ is the final runoff at the basin outlet (m³/s), Q_{sur_sub} is basin outlet runoff output by the Lohmann confluence model (m³/s), and Q_{subper} is the frozen layer groundwater.

Preferably, where the model evaluation indicators include a nash efficiency coefficient, a Kline-Gupta efficiency coefficient, percentage deviation, root mean square error and a determining coefficient.

The disclosure has the following beneficial effects.

Firstly, the model of the disclosure has a flexible modular structure, may be integrated with the most advanced methods or models, and may adjust the model structure and simulation strategy according to local characteristics and data availability.

Secondly, the model of the disclosure may automatically adjust the time step according to the convergence situation to ensure that the model always converges in the iterative calculation process of soil moisture and heat transmission.

Thirdly, the model of the disclosure comprehensively considers the influence of soil freeze-thaw cycle on infiltration, evapotranspiration and water and heat transmission in soil, and greatly improves the simulation ability of runoff process in cold regions.

Fourthly, the model of the disclosure may simulate and analyze the thermal state of permafrost in the region, which is used to study the influence of permafrost degradation on hydrological process under the background of climate change and provide scientific guidance for water resources management in the source areas of rivers and rivers.

### BRIEF DESCRIPTION OF THE DRAWINGS

FIG. 1 is a schematic diagram of a modular coupled water-heat hydrological model for distributed cold regions according to embodiments of the disclosure;

FIG. 2 is an overview of the Yangtze River source basin according to embodiments of the disclosure;

FIG. 3 is a comparison diagram of simulated and measured soil temperatures at different depths of multiple boreholes in a small watershed of Fenghuoshan according to embodiments of the disclosure;

FIG. 4 is a comparison diagram of simulated and measured soil water content at different depths of multiple boreholes in a small watershed of Fenghuoshan according to embodiments of the disclosure;

FIG. 5A1 shows the root mean square error between the simulated value GLEAM3.5a of the total evapotranspiration of the disclosed model and the total evapotranspiration product;

FIG. 5A2 shows the determination coefficient between the simulated value GLEAM3.5a of the total evapotranspiration of the disclosed model and the total evapotranspiration products;

FIG. 5B1 shows the root mean square error between the simulated value GLEAM3.5a of the total evapotranspiration of model GLDAS/Noah and the total evapotranspiration products;

FIG. 5B2 shows the determination coefficient between the simulated value GLEAM3.5a of the total evapotranspiration of GLDAS/Noah and the total evapotranspiration products;

FIG. 5C1 shows the root mean square error between the simulated value GLEAM3.5a of the total evapotranspiration of model GLDAS/VIC and the total evapotranspiration products;

FIG. 5C2 shows the determination coefficient between the simulated value GLEAM3.5a of the total evapotranspiration of model GLDAS/VIC and the total evapotranspiration products;

FIG. 5D1 shows the root mean square error between the simulated value GLEAM3.5a of the total evapotranspiration of model PML_V2 and the total evapotranspiration products;

FIG. 5D2 shows the determination coefficient between the simulated value GLEAM3.5a of the total evapotranspiration of model PML_V2 and the total evapotranspiration products;

FIG. 6A shows the comparison between the simulated daily snow depth and the satellite retrieved daily snow depth;

FIG. 6B shows the comparison between the simulated annual average snow depth and the annual average snow depth retrieved by satellite;

FIG. 6C shows the spatial distribution of simulated multi-year average snow depth;

FIG. 6D shows the spatial distribution of multi-year average snow depth retrieved by satellite;

FIG. 6E shows the root mean square error between the simulated and satellite retrieved multi-year average snow depth;

FIG. 7A shows the comparison of simulated and measured daily runoff,

FIG. 7B shows the comparison between simulated and measured monthly average runoff;

FIG. 7C shows the comparison of simulated and measured multi-year and multi-month average runoff depth; and

FIG. 7D shows the comparison of simulated and measured runoff at different frequencies.

### DETAILED DESCRIPTION OF THE EMBODIMENTS

In order to make the purpose, technical scheme and advantages of the disclosure more clear, the disclosure will be further described in detail with reference to the attached drawings and embodiments.

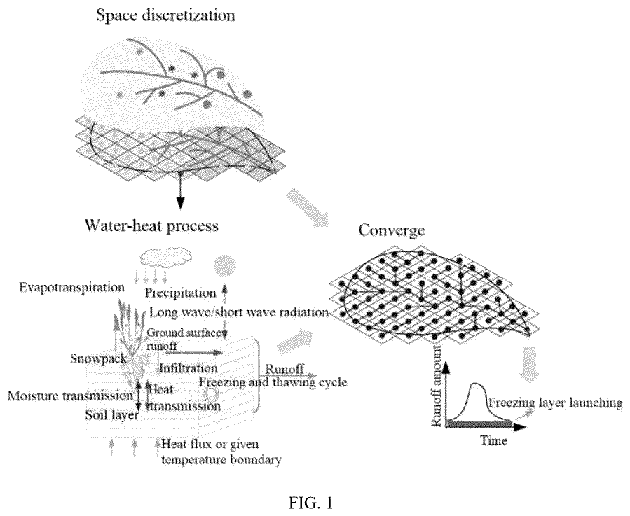

The disclosure provides a construction method for a modular coupled water-heat hydrological model of distributed cold regions, the model includes an energy balance module, an evapotranspiration module, an ice-snow melting module, a soil water-heat transmission and infiltration module, and a runoff generation calculation and flow concentration module, as shown in FIG. 1, where the method includes:
S1, according to elevation data and basin outlet positions, a basin range is extracted by GIS software, a basin is divided into multiple grids, and documents required for a flow concentration process are prepared, such as flow direction data, grid spherical distance and grid area ratio (the ratio of internal grids in the basin is 1, and the ratio of boundary grids in the basin is less than 1);
S2, driving data (air temperature, precipitation, wind speed, relative humidity, incident short-wave radiation, incident long-wave radiation, leaf area index, etc.) and grid feature description data (altitude, soil layer thickness, soil texture, organic matter content, etc.) of each of the grids are prepared;
S3, an energy balance process of soil and vegetation surface is calculated by using the energy balance module.

The net shortwave radiation is calculated:

$${Ns}_{v e g} = {R}_{s} * FVC * [ ( 1 - {α}_{c} ) + {τ}_{c} * ( {α}_{soil / snow} - 1 ) ] ; \\ {Ns}_{soil / snow} = {R}_{s} * ( 1 - {α}_{soil / snow} ) * [ ( 1 - F V C ) + {τ}_{c} * FVC ] ;$$

where, Ns_{veg} is net short-wave radiation absorbed by the vegetation surface (W·m⁻²), Ns_{soil/snow} is net short-wave radiation absorbed by bare soil or snow surface (W·m⁻²), Rₛ is incident short-wave radiation (W·m⁻²), τ_{c} is a proportion of short-wave radiation transmitted by vegetation (-), α_{c} is an albedo of vegetation surface (-), α_{soil/snow} is an albedo of the bare soil or snow surfaces (-), and FVC is vegetation coverage (-).

The net long-wave radiation is calculated:

$$N {l}_{v e g} = FVC * [ {L}_{d} + {L}_{soil / {snow}^{-}} 2 * {L}_{c} ] ; {Nl}_{soil / snow} = ( 1 - FVC ) * {L}_{d} + FVC * {L}_{c} - {L}_{soil / snow} ] ;$$

where, Nl_{veg} is net long-wave radiation absorbed by the vegetation surface (W·m⁻²), Nl_{soil/snow} is net long-wave radiation absorbed by the bare soil or snow surface (W·m⁻²), Le is long-wave radiation emitted by canopy surface (W·m⁻²), L_{d} is incident long-wave radiation (W·m⁻²), and L_{soil/snow} is long-wave radiation emitted by the bare soil or snow surface (W·m⁻²).

Where, surface net radiation is equal to a sum of net short-wave radiation and net long-wave radiation:

$${R}_{n e t} = N s + {N}_{l} ;$$

where, Ns is net short-wave radiation (W·m⁻²), and Nₗ is net long-wave radiation (W·m⁻²).

A calculation formula of surface heat flux is:

$${G}_{0} = 0 \text{.35462} * {R}_{n e t} - 47.79008 .$$

S4, an evapotranspiration process is calculated by using the evapotranspiration module.

The etotal evapotranspiration (Etotal) of each grid consists of three parts: vegetation transpiration (Etrans), interception evaporation (Eint) and soil evaporation (Esoil). Based on the calculated energy balance of vegetation surface and bare soil surface, transpiration, interception evaporation and soil evaporation are calculated respectively. The root ratio of vegetation at different depths is calculated, the calculated transpiration is distributed to each layer of soil according to the root ratio, and the soil evaporation is distributed to the surface soil layer completely. The specific calculation process of each evaporation component is as follows:
a potential evapotranspiration is calculated:

$${E}_{pot} = \frac{Δ * {Q}_{n e} + {ρ}_{a i r} {c}_{a i r} * ( {e}_{s} - {e}_{a} ) / {r}_{a}}{{ρ}_{l i q} {L}_{v} ( Δ + γ * ( 1 + {r}_{c} / {r}_{a} ) )} ;$$

where, Δ is a slope of a curve of saturated vapor pressure changing with temperature (Pa/K), Qₙₑ is available energy (W/m²), and includes potential heat consumed by ice-water phase change, ρₐᵢᵣ is density of air (kg/m³), cₐᵢᵣ is specific heat of air (J/(kg·K)), eₛ is saturated vapor pressure (Pa), eₐ is actual vapor pressure (Pa), rₐ is aerodynamic impedance (s/m), r_{c} is canopy impedance (s/m), γ is a hygrometer constant (Pa·K⁻¹), ρ_{liq} is density of liquid water (kg/m³), and Lᵥ is vaporization potential heat (MJ/kg).

The interception evaporation on the canopy surface is calculated:

$${E}_{int} = {( \frac{{Int}_{sto}}{{Max}_{it}} )}^{2 / 3} * {E}_{pot} * Δ t * min ( 1 , * \frac{{( {Int}_{sto} * {Max}_{it}^{2} )}^{1 / 3}}{{E}_{pot} * Δ t} ) ;$$

where, Intₛₜₒ is interception water output (m), Maxᵢₜ is a maximum interception water storage capacity (m), and Δt is a time step (s), when calculating the Eₚₒₜ here, r_{c} should be taken as 0.

The transpiration of the canopy surface is calculated:

$${f}_{d r y} = 1 - f * {( \frac{{Int}_{s t o}}{{Max}_{i t}} )}^{2 / 3} ; \\ {E}_{t r a n s} = {E}_{pot} * {f}_{dry} * roo {t}_{frac , i} * Δ t ;$$

where, f_{dry} is a dry ratio of the canopy surface, Eₜᵣₐₙₛ is the transpiration of the canopy surface (m), and root_{frac,i} is a root ratio in an i-th layer soil layer.

The soil evaporation is calculated:

$${E}_{soil} = min ( {E}_{pot} * Δ t , {( \frac{8 * {η}_{1} * {K}_{sat} * ( - {Ψ}_{e} )}{3 ( 1 + 3 m ) ( 1 + 4 m )} )}^{1 / 2} * {( \frac{{θ}_{1}}{{η}_{1}} )}^{1 / 2} {( Δ t )}^{\frac{1}{2}} ) ;$$

where, θ₁ is liquid water content of surface soil, η₁ is a porosity of the surface soil, Kₛₐₜ is a saturated hydraulic conductivity of the soil, m is a reciprocal of Campbell pore size distribution index, and Ψₑ is air entry potential (m), when calculating Eₚₒₜ here, r_{c} should be taken as 0.

S5, an ice-snow melting process is calculated by adopting a degree-day factor method by using the ice-snow melting module.

The melting process of ice and snow is calculated by degree-day factor method, a snow melting process is calculated by a following formula:

$${M}_{s n o w} = \{ \begin{matrix}{DDF}_{s n o w} * ( {T}_{a i r} - {T}_{s n o w} ) + S R {F}_{s n o w} * N {s}_{s n o w} & {T}_{a i r} > {T}_{s n o w} \\ 0 & {T}_{a i r} \leq {T}_{s n o w}\end{matrix} ;$$

where, M_{snow} is a snow melting amount, DDF_{snow} is a snow melting degree-day factor (mm·° C.⁻¹·day⁻¹), SRF_{snow} is a short-wave radiation factor (mm·W⁻¹·m²·day⁻¹), Ns_{snow} is a snow melting surface net short-wave radiation (W·m⁻²), Tₐᵢᵣ is air temperature (° C.), and T_{snow} represents a highest temperature threshold value when precipitation is snowfall (° C.).

Where, a glacier zone method with a degree-day factor method and an area volume-ratio method are combined to simulate a glacier runoff process includes:

firstly, each glacier is divided into several “glacier zones” at the interval of 100 m altitude difference, and the temperature (T_{band}, ° C.) and precipitation data (P_{band}, mm) of each “glacier zone” are interpolated by using the MicroMet model, and the area ratio (A_{frac,i}) of each “glacier zone” in each grid is calculated;

the rain and snow are divided based on the air temperature (T_{band}, ° C.) and precipitation data (P_{band}, mm) of each of the glacier zones obtained by interpolation, a rainfall amount (P_{rain,band}, mm) and a snowfall amount (P_{snow,band}, mm) of each of the glacier zones are obtained, and a snow water equivalent amount of each of the glacier zones is calculated;

when air temperature drops below a snow melting threshold temperature, a potential snow melting amount (M_{snow,band}) is calculated by the degree-day factor method, and a snow water equivalent amount in a current glacier zone is compared; if the potential snow melting amount is less than the snow water equivalent amount, the snow melting process is only occurred, otherwise a underlying glacier begins to melt:

$${M}_{b a n d} \{ \begin{matrix}{M}_{snow , band} {SWE}_{band} \geq {M}_{snow , band} > 0 \\ {SWE}_{band} + [ {M}_{snow , band} - {SWE}_{band} ] * \frac{{DDF}_{ice}}{{DDF}_{snow}} \\ {DDF}_{ice} * ( {T}_{band} - {T}_{melt} ) {SWE}_{band} = 0\end{matrix}$$

$$0 < SW {E}_{b a n d} < {M}_{snow , band} ;$$

where, M_{band} represents total snow and glacier melting water (mm), DDF_{ice} is a glacier melting degree-day factor (mm/(° C.·day)), SWE_{band} is snow water equivalent amount (mm) of the current glacier zone, M_{snow, band} is the potential snow melting amount (mm), T_{band} is air temperature (° C.) of the glacier zone, and Tₘₑₗₜ is a melting temperature (° C.) of snow or glacier, and is taken as 0° C. in this embodiment.

Where a runoff depth of each of the glacier zones is equal to a sum of a rainfall amount and a total melting water of snow and ice; on scale of each of the grids, a runoff depth of a glacier area is equal to a sum of products of all glacier zone runoff generation amounts and an area ratio contained in the grid:

$${R}_{band , i} = {P}_{rain , band , i} + {M}_{b a n d} ;$$

$${R}_{glacier} = {\sum }_{i = 1}^{n} {A}_{frac , i} * {R}_{band , i} ;$$

where, i is a number of each of the glacier zones, n is a number of the glacier zones, P_{rain,band,i} is a rainfall amount (mm) of the i-th glacier zone, R_{glacier} is a runoff depth (mm) of the glacier area, M_{band,i} is an ice and snow melting water amount (mm) of the i-th glacier zone, A_{frac,i} is an area proportion of the i-th glacier zone in the grid, and R_{band,i} is a runoff depth (mm) of an i-th glacier zone.

The key of the above-mentioned “glacier zone” ice and snow melting simulation algorithm lies in the simulation of glacier retreat or advance. At present, the estimation methods of glacier area evolution maybe roughly divided into two categories. One is an ice-flow model to predict the movement and deformation of ice based on physical properties, mechanical processes and surrounding environmental conditions of ice. However, this method needs detailed geometric information of glacier surface and basement, so the application in areas with scarce data is limited. The volume-area ratio method, which requires less parameters, is widely used to simulate the change of glacier area;

$${A}_{glacier} = {( \frac{{V}_{glacier}}{C} )}^{\frac{1}{γ}} ;$$

where, A_{glacier} is the area (km²) of the glacier, and V_{glacier} is the volume (km³) of the glacier, the constant c is taken as 0.0365 and the scale factor γ is taken as 1.375.

The volume of glacier is updated every year according to the simulated glacier melting, and the area of glacier is calculated according to the updated glacier volume. The area of each “glacier zone” is updated according to the adjusted glacier area, and it is assumed that the retreat or advance of glaciers first occurs in the “glacier zone” with the lowest altitude. When glaciers retreat, the area of the “glacier zone” at the lowest altitude will shrink. If the calculated glacier shrinkage area is greater than the area of the lowest “glacier zone”, the glacier area of this “glacier zone” will be set to 0, and the glacier area of the adjacent upper-level “glacier zone” will be reduced by the remaining shrinkage area. On the contrary, when the glacier advances, the glacier area of the lowest “glacier zone” will increase and be limited to the initial input area, otherwise a new “glacier zone” will be introduced.

S6, soil moisture infiltration and an internal water-heat transmission process are calculated by using the soil water-heat transmission and infiltration module.

The multi-layer soil structure is adopted to reflect a water-heat transmission process in soil. The division of soil thickness may be specified by the user or determined by exponential stratification method:

$${z}_{i} = {f}_{s} \{ {e}^{( 0.5 ( i - 0.5 ) )} - 1 \} ;$$

$$Δ {z}_{i} = \{ \begin{matrix}0.5 ( {z}_{1} + {z}_{2} ) & i = 1 \\ 0.5 ( {z}_{i + 1} - {z}_{i - 1} ) & i = 2 , 3 , … , n - 1 \\ {z}_{i} - {z}_{i - 1} & i = n\end{matrix} ;$$

where zᵢ is the depth of the i-th soil layer, fₛ is the scale factor, which is taken as 0.025 in this embodiment, and Δzᵢ is the thickness of the i-th soil layer. In the exponential stratification method, the soil layer closer to the surface is thinner because of high sensitivity to meteorological driving. In each time step, the basic calculation process of water and heat transmission in soil layer is as follows:
S61, hydrothermal parameters of soil are calculated based on current soil liquid water content, ice content and organic matter content, where the hydrothermal parameters include thermal conductivity, hydraulic conductivity, volumetric heat capacity and moisture flux;
S62, a heat transmission equation is solved to obtain a temperature of each layer of soil;
S63, soil liquid water content and ice content, hydraulic conductivity and moisture flux are updated based on a latest calculated soil temperature;
S64, a Richard equation of considering ice-water phase transition is solved to obtain water content and ice content of each layer of soil;
S65, S61-S64 are repeated, until errors of soil temperature and soil moisture reach a convergence standard, in this embodiment, the convergence standard are: ΔT<0.001° C., Δθ<0.01 m³/m³, ΔT is the soil temperature error of the previous two iterations, and Δθ is the soil moisture error of the previous two iterations; and
S66, a water infiltration process is calculated by a multi-layer Green-Ampt algorithm, and soil moisture and soil temperature are updated.

The water-heat transmission process in the soil layer is calculated by a following formula:
for each layer of soil, the change of soil temperature is calculated by using the heat conduction-convection equation and considering the phase change of ice water:

$${C}_{s} \frac{\partial T}{\partial t} - {L}_{f} {ρ}_{i c e} \frac{\partial {θ}_{i c e}}{\partial t} = \frac{\partial }{\partial z} [ {λ}_{s} \frac{\partial T}{\partial z} ] - {C}_{l i q} \frac{\partial {q}_{l} T}{\partial z} ;$$

where, Cₛ is volumetric heat capacity (J·kg⁻¹·° C.⁻¹) of soil, λₛ is a thermal conductivity (W·m⁻¹·° C.⁻¹) of the soil, ρ_{ice} is density (kg·m⁻³) of ice, θ_{ice} is a volumetric ice content (m³·m⁻³), qₗ is a liquid moisture flux (m·s⁻¹), C_{liq} is volumetric heat capacity (J·kg⁻¹·° C.⁻¹) of liquid water, T is a temperature (° C.) of the soil, Z is a depth (m) of the soil, and L_{f} is melting potential (3.35×105 J·kg⁻¹).

The volumetric heat capacity of the soil is expressed as a weighted sum of volumetric heat capacities of various components in the soil:

$${C}_{s} = ( 1 - organic ) * {ρ}_{b} * {c}_{m} + organic * {ρ}_{b} * {c}_{o} + {θ}_{liq} * {ρ}_{liq} * {c}_{liq} + {θ}_{i c e} * {ρ}_{i c e} * {c}_{i c e} + {θ}_{air} * {ρ}_{air} * {c}_{air} ;$$

where, ρ_{b} is soil bulk density, cₘ is specific heat of minerals (900 J/(kg·° C.)), cₒ is specific heat of organic matter (1920 J/(kg·° C.)), θₐᵢᵣ is volume fraction of air, θ_{liq} is a water content of liquid water (m³·m⁻³), and organic is volume fraction of the organic matter.

The thermal conductivity of the soil is obtained by combining dry state thermal conductivity and saturated state thermal conductivity weighted by Kersten number:

$${λ}_{s} = ( {λ}_{s a t} - {λ}_{d r y} ) * {K}_{e} + {λ}_{d r y} ;$$

where, Kₑ is a function of soil saturation and the volume fraction of the organic matter, λ_{dry} is soil dry state thermal conductivity, and λₛₐₜ is soil saturated state thermal conductivity.

$${K}_{e} = \{ \begin{matrix}{S}_{r}^{( 1 + organic - {av}_{sand} - {v}_{gravel} ) {\{ {[ \frac{1}{1 + {e}^{- β {s}_{r}}} ]}^{3} - {( \frac{1 - {S}_{r}}{2} )}^{3} \}}^{1 - organic}} unfreezed soil \\ {S}_{r}^{1 + organic} frozen soil\end{matrix} ;$$

where, Sᵣ is the soil saturation, v_{sand} is volume fraction of sand, v_{gravel} is volume fraction of gravel, and α (0.24 in this embodiment) and β (18.1 in this embodiment) are adjustment factors; a relationship between Kₑ and Sᵣ is used to predict a continuous change of thermal conductivity in a whole soil saturation level and particle size distribution range, so as to be suitable for a calculation of thermal conductivity of permafrost in arid and semi-arid areas.

In cold areas, when soil temperature is higher than a freezing point, matrix potential is expressed as a function of liquid water content. However, when temperature drops below the freezing point, the matrix potential (ignoring the osmotic potential) drops rapidly, and is given by a freezing point water potential equation:

$$Ψ = \{ \begin{matrix}\frac{{L}_{f} \cdot T}{g * ( T + 273.15 )} & T \leq {T}_{f} \\ {Ψ}_{e} * {( \frac{{θ}_{liq}}{{θ}_{sat}} )}^{- b} & T > {T}_{f}\end{matrix} ;$$

where, Ψ is soil matrix potential (m), b is Campbell pore size distribution index, T_{f} is the freezing point (0° C. in this embodiment), θₛₐₜ is saturated water content (m³/m³), and g is gravity acceleration (9.8 m/s²).

In the process of soil freezing, the matrix potential at the freezing front decreases rapidly, and the unfrozen soil moisture migrates to the freezing front under the action of matrix potential gradient. The discontinuity of soil interface water content between soil layers makes the traditional water flow description based on water content gradient unsuitable. Therefore, the matrix potential gradient is used to describe the movement of moisture:

$${q}_{l} = {K}_{eff} \cdot ( \frac{\partial Ψ}{\partial z} + 1 ) ;$$

where, K_{eff} is effective hydraulic conductivity (m·s⁻¹).

In the process of soil freezing, because the flow velocity depends on the cross-sectional area of the flow channel and the geometry of the pores, with the accumulation of soil ice in the pores, the soil hydraulic conductivity will decrease rapidly. When the soil begins to freeze, blocking effect of soil ice on moisture transmission is considered by introducing a blocking factor E:

$${K}_{eff} = \{ \begin{matrix}{K}_{sat} * {( \frac{Ψ}{{Ψ}_{e}} )}^{( 2 + 3 / b )} & {θ}_{ice} = 0 \\ {K}_{sat} * {( \frac{Ψ}{{Ψ}_{e}} )}^{( 2 + 3 / b )} * {10}^{- E * {m}_{ice}} & {θ}_{ice} > 0\end{matrix} ;$$

$${m}_{i c e} = \frac{{ρ}_{i c e} * {θ}_{i c e}}{{ρ}_{i c e} * {θ}_{i c e} + {ρ}_{l i q} * {θ}_{l i q}} ;$$

where, E is the blocking factor, and m_{ice} is a ratio of ice content to total water content.

Assuming that the soil medium is incompressible, and water vapor migration is ignored, according to Darcy's law and mass conservation principle, a basic equation of soil moisture movement is obtained:

$$\frac{\partial {θ}_{l i q}}{\partial t} = \frac{\partial }{\partial z} [ {K}_{eff} ( \frac{\partial Ψ}{\partial z} + 1 ) ] - \frac{{ρ}_{i c e}}{{ρ}_{l i q}} \frac{\partial {θ}_{i c e}}{\partial t} + S ;$$

where S is source sink term in the water flux.

S7, a runoff amount is calculated by using the runoff generation calculation and concentration module.

S71, surface runoff depth and underground runoff depth of each of the grids are calculated.

Melting snow and rain piercing through the forest are the sources of infiltration moisture. The surface water reserve is equal to the difference between the sum of the rain piercing through the forest and the melting snow amount and the total accumulated infiltration. The surface runoff is calculated by the following formula:

$${R}_{s u r} = max ( 0 , [ ( {P}_{rain} + {M}_{s n o w} ) - Infil - P o n {d}_{max} ] * ( 1 - {glacier}_{f r a c} ) + {glacier}_{f r a c} * {R}_{glacier} ) ;$$

where, Pᵣₐᵢₙ is rainfall amount (mm) of the grid, Pondₘₐₓ is a maximum allowable water depth (mm), Infil is a total accumulated water seepage amount (mm), and glacier_{frac} is a proportion of glacier area in the grid.

In the process of soil freezing and melting, the freezing front or melting front will temporarily act as a water-resisting layer, which makes it difficult to distinguish the frozen layer groundwater and the interflow of soil. Therefore, underground runoff is used to describe the process of underground runoff production; underground runoff of an i-th layer soil is:

$${R}_{s u b , i} = \{ \begin{matrix}( {θ}_{l i q} - {θ}_{f} ) * Δ {z}_{i} / Δ t * {α}_{r} * Δ t & {θ}_{l i q} > {θ}_{f} \\ 0 & {θ}_{l i q} \leq {θ}_{f}\end{matrix} ;$$

where, θ_{f} is a field capacity, Δzᵢ is a thickness of the i-th layer soil, and αᵣ is an underground runoff factor (-).

A total underground runoff is a sum of R_{sub,i} of all soil layers above bedrock.

S72, a confluence process is calculated.

Based on a confluence file prepared the elevation data, driven by simulated output surface runoff depth and underground runoff depth, and a process of slope surface confluence and river network confluence are calculated by a Lohmann confluence model, basin outlet runoff is obtained; in the cold season, the river flow in the permafrost basin is mainly maintained by frozen layer groundwater, and Q90 in the flow duration curve is used to represent frozen layer groundwater. Based on the runoff variation characteristics of many rivers in the permafrost regions of Siberia and Tibetan Plateau in recent decades, an empirical relationship between annual average air temperature, annual average precipitation, permafrost coverage rate and frozen layer groundwater is built:

$${Q}_{s u b p e r} = δ + {β}_{1} \overline{T} + {β}_{2} \overline{P} + {β}_{3} \overline{{Per}_{c o v e r}} .$$

Where, δ, β₁, β₂ and β₃ are fitting parameters, T̅ is the multi-year moving average of air temperature (° C.), P̅ is the multi-year moving average of precipitation (mm), and P̅e̅r̅_̅{̅c̅o̅v̅e̅r̅}̅ is the multi-year moving average of permafrost coverage (%). Lohmann confluence model is used to calculate the confluence process, and the daily surface runoff depth and underground runoff depth are used to drive Lohmann confluence model to calculate the process between slope surface confluence and river network confluence. Lohmann confluence model converges runoff to the outlet of a given grid, and then adds it to the river network confluence model that couples all grids together. By solving the linear Saint-Venant equation, the confluence process of river network is estimated to obtain the runoff at the outlet of the basin. The final runoff at basin outlet is a sum of output of the Lohmann confluence model and output of a freezing layer groundwater module, namely:

$${Q}_{total} = {Q}_{sur \_ sub} + {Q}_{s u b p e r} ;$$

where, Qₜₒₜₐₗ is the final runoff at the basin outlet (m³/s), Q_{sur_sub} is basin outlet runoff output by the Lohmann confluence model (m³/s), and Q_{subper} is the frozen layer groundwater.

S8, simulation performance of the model is evaluated by model evaluation indicators.

The model evaluation indicators include:
a nash efficiency coefficient:

$$NSE = 1 - \frac{{\sum }_{i = 1}^{n} {( {S}_{i} - {O}_{i} )}^{2}}{{\sum }_{i = 1}^{n} {( {O}_{i} - \overline{O} )}^{2}} ;$$

a Kline-Gupta efficiency coefficient:

$$K G E = 1 - \sqrt{{( R - 1 )}^{2} + {( \frac{{σ}_{S}}{{σ}_{O}} - 1 )}^{2} + {( \frac{\overline{S}}{\overline{O}} - 1 )}^{2}} ;$$

percentage deviation:

$$Pbias = 100 * \frac{{\sum }_{i = 1}^{n} ( {S}_{i} - {O}_{i} )}{{\sum }_{i = 1}^{n} {O}_{i}} ;$$

root mean square error:

$$RSME = \sqrt{\frac{1}{n} {\sum }_{i = 1}^{n} {( {S}_{i} - {O}_{i} )}^{2}} ;$$

a determining coefficient:

$${R}^{2} = \frac{{[ {\sum }_{i = 1}^{n} ( {S}_{i} - \overline{S} ) * ( {O}_{i} - \overline{O} ) ]}^{2}}{{\sum }_{i = 1}^{n} {( {S}_{i} - \overline{S} )}^{2} * {\sum }_{i = 1}^{n} {( {O}_{i} - \overline{O} )}^{2}} ;$$

where, Oᵢ is the observed value, Sᵢ is the simulated value, Ō is the average value of the observed value, S̅ is the average value of the simulated value, σ₀ is the standard deviation of the observed value, σₛ is the standard deviation of the simulated value, n is the number of samples, and R is the correlation coefficient.

In a specific embodiment, the Yangtze River source basin with the largest permafrost coverage on the Tibetan Plateau is selected as the research area, and the soil temperature and soil water content data of the measured stations in the basin are selected to evaluate the simulation ability of the soil hydrothermal process of the modular coupled water-heat hydrological model of distributed cold regions proposed by the disclosure. GLEAM evapotranspiration data is selected as reference data, and the simulation results of the model proposed in this disclosure and the data results of mainstream GLDAS/Noah, GLDAS/VIC and PML_V2 models are simultaneously compared and analyzed with GLEAM to evaluate the evapotranspiration simulation ability of the model proposed in this disclosure. SSM/I, SSMIS, AMSR-E, AMSR2 and other snow depth satellite inversion products are selected to evaluate the snow melting process simulation ability of the model proposed in this disclosure. The runoff data (2001-2017) of Zhimenda Hydrological Station at the outlet of river basin is selected to evaluate the runoff simulation ability of the model proposed in this disclosure.

The source region of the Yangtze River is located in the permafrost region in the middle of the Tibetan Plateau, with a basin area of 158096 km² and an altitude range of 3,500-6,500 m. The permafrost coverage rate in the basin is as high as 80%, the permafrost thickness is 10-120 m, and the active layer thickness is 1-4 m. It belongs to a typical permafrost basin. The annual average temperature in the source region of the Yangtze River ranges from −5.5° C. to −1.7° C., showing a general trend of high in the southeast and low in the northwest in spatial distribution, with typical climate characteristics of inland plateau. The annual precipitation varies from 260 to 496 mm, and mainly (80%) is concentrated in summer and autumn, with little snowfall in winter. The annual runoff in the basin is the largest from May to September, and the peak precipitation is delayed for one month, accounting for about 80% of the total annual runoff. From 1986 to 2009, the average annual runoff of Zhimenda Hydrological Station at the outlet of the basin is 13.8×109 m³, and the average runoff coefficient is 0.20.

The implementation steps are as follows.

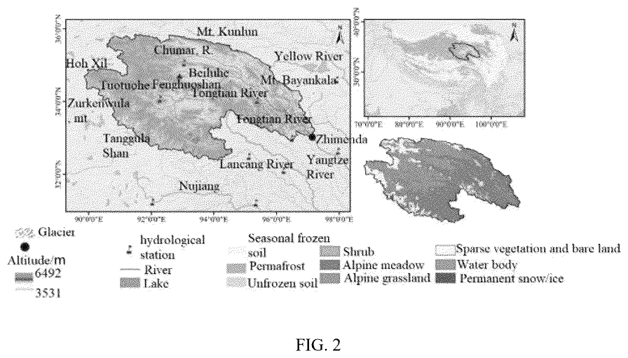

Step 1: the data required for running the model proposed by the disclosure in the Yangtze River source basin as shown in FIG. 2 is collected and sorted out, including elevation data, precipitation data, air temperature data, wind speed data, relative humidity data, downward short-wave radiation and downward long-wave radiation data and leaf area index data, and the software required for data processing and model operation is installed, such as ArcGIS, Python, etc. Where, the data of air temperature, wind speed, incident short-wave radiation and incident long-wave radiation come from the ground meteorological element driven data set (CMFD) in China, and the data of relative humidity come from the ERA5-Land data set. The thin-plate spline curve method is used to interpolate the data of China Meteorological Bureau, and the precipitation data of the whole source region of the Yangtze River are obtained. The precipitation data obtained by interpolation are fused with the precipitation data in CMFD and ERA5-Land data sets by triple collocation method, which is used to finally drive the model. The leaf area index data in GLASS data set and GIMMS data set are collectively averaged as the leaf area index data needed for the final operation of the model. Elevation data, vegetation type data and glacier distribution data are from the National Plateau Scientific Data Center of Tibetan Plateau. Soil texture data and organic matter content data are derived from the basic attribute data set of China high-resolution national soil information grid.

Step 2: nash efficiency coefficient (NSE), Kline-Gupta efficiency coefficient (KGE), percentage deviation (Pbias), root mean square error (RMSE) and determining coefficient (R2) are taken as objective functions, the model parameters are calibrated, and the simulation performance of the model is evaluated from soil temperature and humidity, evapotranspiration, snow depth and runoff.

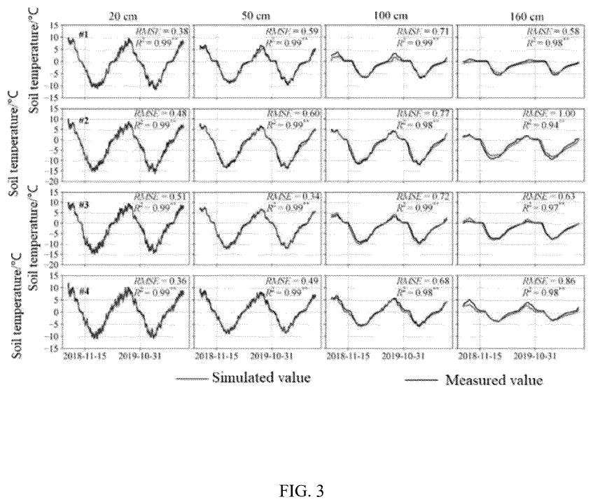

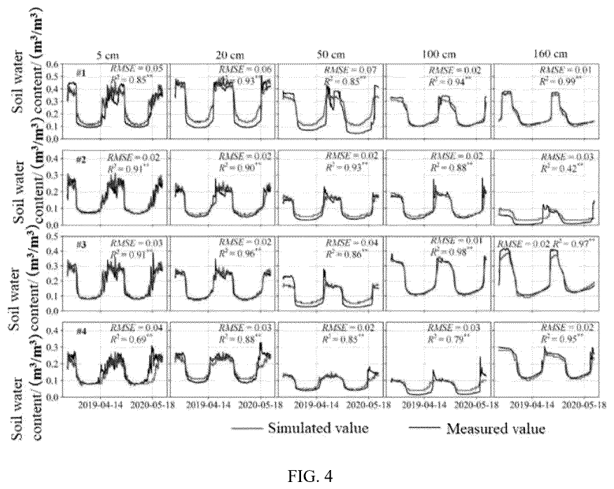

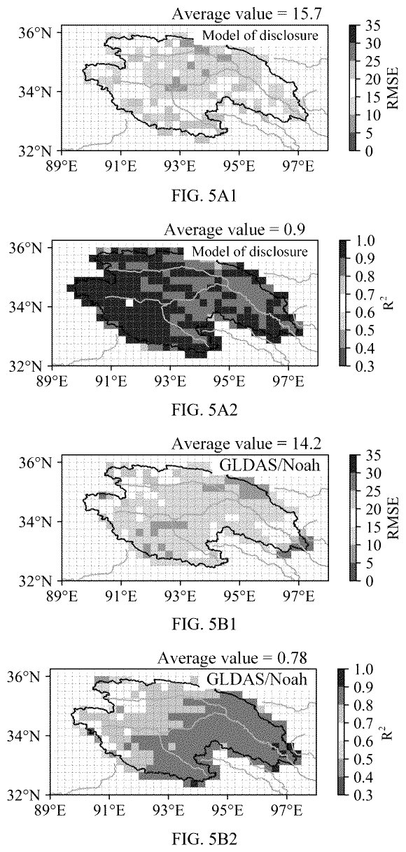

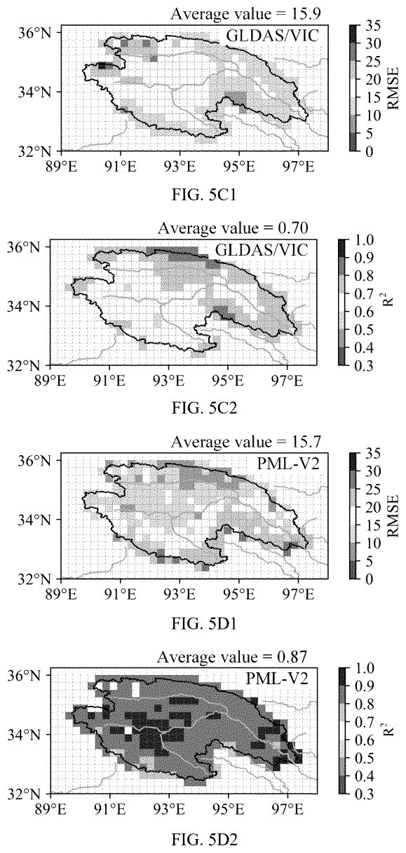

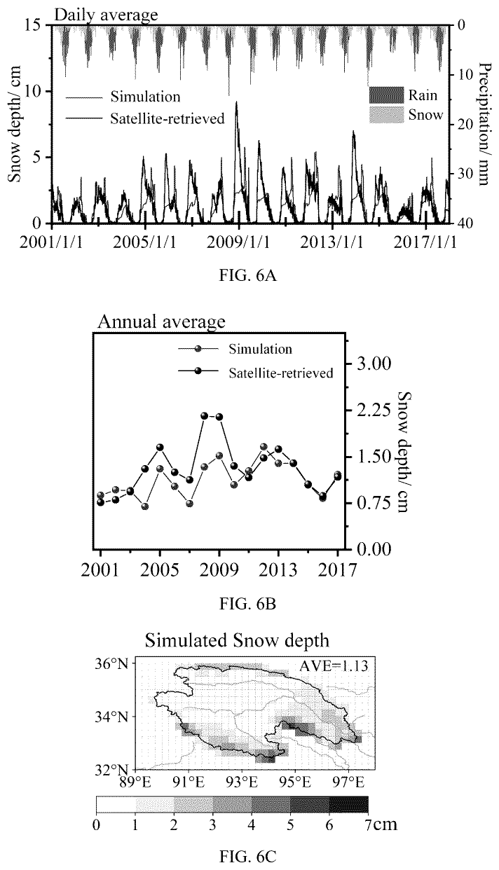

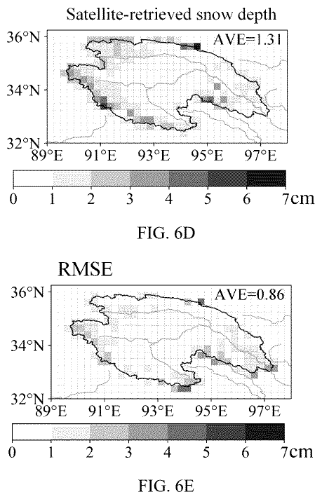

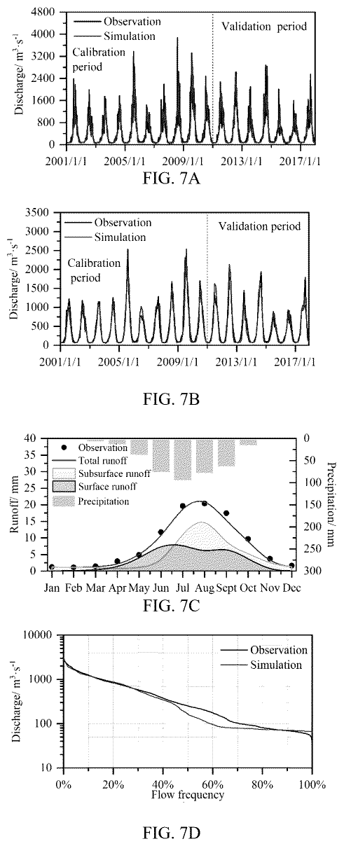

The simulation results of soil temperature and soil liquid water content after the implementation of the technical scheme are shown in FIG. 3 and FIG. 4, respectively. The model proposed in this disclosure accurately captures the dynamic changes of soil temperature (average R²=0.98, average RMSE=0.63° C.) and liquid water content (average R²=0.87, average RMSE=0.03 m³/m⁻³) under different underlying surface conditions, including potential heat effect and ice-water phase transition during freezing and melting. The simulation results of total evapotranspiration are shown in FIGS. 5A1-5A2, 5B1-5B2, 5C1-5C2, 5D1-5D2. The average RMSE between monthly evapotranspiration and GLEAM data simulated by the model proposed in this disclosure is only 15.7 mm, and the average R² is as high as 0.9. The overall performance is better than that of GLDAS/Noah, GLDAS/VIC and PML_V2 models, which shows the superiority of the model proposed in this disclosure in evapotranspiration simulation in cold regions. The simulation results of snow depth are shown in FIGS. 6A-6E. The average snow depth of the model simulation and satellite inversion proposed in this disclosure is 1.13 cm and 1.31 cm respectively, and the average RMSE between the simulated snow depth and satellite inversion value is only 0.86 cm, which proves that the model proposed in this disclosure may reasonably simulate and reproduce the temporal and spatial changes of snow depth in cold regions. The results of runoff simulation are shown in FIGS. 7A-7D. On the monthly scale, the model of the disclosure obtained more accurate simulation results during calibration, with NSE of 0.88, KGE of 0.87, R² of 0.89 and Pbias of −6.86%. After parameter calibration, the simulation ability of the model is still excellent, and the values of NSE, KGE, R² and Pbias are 0.85, 0.90, 0.86 and −5.86% respectively. Generally speaking, considering the complex cold region environment, high spatial heterogeneity and scarce data, the modular coupled water-heat hydrological model of distributed cold regions proposed in this disclosure has excellent runoff simulation ability and may be used to simulate runoff process in complex cold region environment. The evaluation index results of the modular coupled water-heat hydrological model of distributed cold regions proposed in this disclosure are shown in Table 1.

TABLE 1
Evaluation index of the modular coupled water-heat
hydrological model of distributed cold regions in
runoff simulation of Yangtze River source basin

| time scale | stage | R² | NSE | KGE | Pbias |
|---|---|---|---|---|---|
| daily | certain rate | 0.70 | 0.68 | 0.82 | −6.75% |
| | period | | | | |
| | verification | 0.73 | 0.70 | 0.84 | −5.66% |
| | period | | | | |
| monthly | certain rate | 0.86 | 0.86 | 0.90 | −6.86% |
| | period | | | | |
| | verification | 0.87 | 0.86 | 0.90 | −5.86% |
| | period | | | | |
| average for | 2001-2017 | 0.98 | 0.97 | 0.93 | −6.45% |
| many years | | | | | |
| and months | | | | | |

The basic principle, main features and advantages of the disclosure have been shown and described above. It should be understood by those skilled in the art that the disclosure is not limited by the above-mentioned embodiments, and what is described in the above-mentioned embodiments and descriptions only illustrates the principles of the disclosure. Without departing from the spirit and scope of the disclosure, there will be various changes and improvements in the disclosure, which fall within the scope of the claimed disclosure. The scope of the disclosure is define by the appended claim and their equivalents.

What is claimed is:

1. A construction method for a modular coupled water-heat hydrological model of distributed cold regions, wherein the model comprises an energy balance module, an evapotranspiration module, an ice-snow melting module, a soil water-heat transmission and infiltration module, and a runoff generation calculation and flow concentration module, wherein the method comprises:
S1, according to elevation data and basin outlet positions, extracting a basin range, dividing a basin into a plurality of grids, and preparing documents required for a flow concentration process;
S2, preparing driving data and grid feature description data of each of the grids;
S3, calculating an energy balance process of soil and vegetation surface by using the energy balance module;
S4, calculating an evapotranspiration process by using the evapotranspiration module;
S5, calculating an ice-snow melting process by adopting a degree-day factor method by using the ice-snow melting module;
S6, calculating soil moisture infiltration and an internal water-heat transmission process by using the soil water-heat transmission and infiltration module;
S7, calculating a runoff amount by using the runoff generation calculation and concentration module; and
S8, evaluating simulation performance of the model by model evaluation indicators.

2. The construction method for a modular coupled water-heat hydrological model of distributed cold regions according to claim 1, wherein the S3 comprises:
calculating net shortwave radiation:
$$N {s}_{v e g} = {R}_{s} * FVC * [ ( 1 - {α}_{c} ) + {τ}_{c} * ( {α}_{soil / snow} - 1 ) ] ;$$
$${Ns}_{soil / snow} = {R}_{s} * ( 1 - {α}_{soil / snow} ) * [ ( 1 - F V C ) + {τ}_{c} * FVC ] ;$$
wherein, Ns_{veg} is net short-wave radiation absorbed by the vegetation surface, Ns_{soil/snow} is net short-wave radiation absorbed by bare soil or snow surface, Rₛ is incident short-wave radiation, τ_{c} is a proportion of short-wave radiation transmitted by vegetation, α_{c} is an albedo of vegetation surface, α_{soil/snow} is an albedo of the bare soil or snow surfaces, and FVC is vegetation coverage; and
calculating net long-wave radiation:
$$N {l}_{v e g} = FVC * [ {L}_{d} + {L}_{soil / snow} - 2 * {L}_{c} ] ;$$
$${Nl}_{soil / snow} = ( 1 - F VC ) * {L}_{d} + FVC * {L}_{c} - {L}_{soil / snow} ] ;$$
wherein, Nl_{veg} is net long-wave radiation absorbed by the vegetation surface, Nl_{soil/snow} is net long-wave radiation absorbed by the bare soil or snow surface, L_{c} is long-wave radiation emitted by canopy surface, L_{d} is incident long-wave radiation, and L_{soil/snow} is long-wave radiation emitted by the bare soil or snow surface;
wherein, surface net radiation is equal to a sum of net short-wave radiation and net long-wave radiation:
$${R}_{n e t} = N s + {N}_{l} ;$$
wherein, Ns is net short-wave radiation, and Nₗ is net long-wave radiation;
a calculation formula of surface heat flux is:
$${G}_{0} = 0 \text{.35462} * {R}_{n e t} - 47.79008 ;$$
wherein, G₀ is the surface heat flux.

3. The construction method for a modular coupled water-heat hydrological model of distributed cold regions according to claim 2, wherein the S4 comprises:
calculating a potential evapotranspiration:
$${E}_{pot} = \frac{Δ * {Q}_{n e} + {ρ}_{a i r} {c}_{a i r} * ( {e}_{s} - {e}_{a} ) / {r}_{a}}{{ρ}_{l i q} {L}_{v} ( Δ + γ * ( 1 + {r}_{c} / {r}_{a} ) )} ;$$
wherein, Δ is a slope of a curve of saturated vapor pressure changing with temperature, Qₙₑ is available energy, and comprises potential heat consumed by ice-water phase change, ρₐᵢᵣ is density of air, cₐᵢᵣ is specific heat of air, eₛ is saturated vapor pressure, eₐ is actual vapor pressure, rₐ is aerodynamic impedance, r_{c} is canopy impedance, γ is a hygrometer constant, ρ_{liq} is density of liquid water, and Lᵥ is vaporization potential heat;
calculating interception evaporation on the canopy surface:
$${E}_{int} = {( \frac{{Int}_{sto}}{{Max}_{it}} )}^{2 / 3} * {E}_{pot} * Δ t * min ( 1 , * \frac{{( {Int}_{sto} * {Max}_{it}^{2} )}^{1 / 3}}{{E}_{pot} * Δ t} ) ;$$
wherein, Intₛₜₒ is interception water output, Maxᵢₜ is a maximum interception water storage capacity, and Δt is a time step;
calculating transpiration of the canopy surface:
$${f}_{dry} = 1 - f * {( \frac{{Int}_{sto}}{{Max}_{it}} )}^{2 / 3 ;}$$
$${E}_{t r a n s} = {E}_{pot} * {f}_{dry} * {root}_{frac , i} * Δ t ;$$
wherein, f_{dry} is a dry ratio of the canopy surface, Etrans is the transpiration of the canopy surface, and root_{frac,i} is a root ratio in an i-th layer soil layer; and
calculating soil evaporation:
$${E}_{soil} = min ( {E}_{pot} * Δ t , {( \frac{8 * {η}_{1} * {K}_{sat} * ( - {Ψ}_{e} )}{3 ( 1 + 3 m ) ( 1 + 4 m )} )}^{1 / 2} * {( \frac{{θ}_{1}}{{η}_{1}} )}^{1 / 2} {( Δ t )}^{\frac{1}{2}} ) ;$$
wherein, θ₁ is liquid water content of surface soil, η₁ is a porosity of the surface soil, Kₛₐₜ is a saturated hydraulic conductivity of the soil, m is a reciprocal of Campbell pore size distribution index, and Ψₑ is air entry potential.

4. The construction method for a modular coupled water-heat hydrological model of distributed cold regions according to claim 3, wherein the S5 comprises:
calculating a snow melting process by a following formula:
$${M}_{snow} = \{ \begin{matrix}{DDF}_{snow} * ( {T}_{air} - {T}_{snow} ) + {SRF}_{snow} * {Ns}_{snow} & {T}_{air} > {T}_{snow} \\ 0 & {T}_{air} \leq {T}_{snow}\end{matrix} ;$$
wherein, M_{snow} is a snow melting amount, DDF_{snow} is a snow melting degree-day factor, SRF_{snow} is a short-wave radiation factor, Ns_{snow} is a snow melting surface net short-wave radiation, Tₐᵢᵣ is air temperature, and T_{snow} represents a highest temperature threshold value when precipitation is snowfall;
wherein combining a glacier zone method with a degree-day factor method and an area volume-ratio method to simulate a glacier runoff process comprises:
dividing each glacier into a plurality of glacier zones, interpolating air temperature and precipitation data of each of the glacier zones, and calculating an area ratio of each of the glacier zones in each of the grids; and
dividing rain and snow based on the air temperature and precipitation data of each of the glacier zones obtained by interpolation, obtaining a rainfall amount and a snowfall amount of each of the glacier zones, and calculating a snow water equivalent amount of each of the glacier zones;
when air temperature drops below a snow melting threshold temperature, calculating a potential snow melting amount by the degree-day factor method, and comparing with a snow water equivalent amount in a current glacier zone; if the potential snow melting amount is less than the snow water equivalent amount, only occurring the snow melting process, otherwise a underlying glacier begins to melt:
$${M}_{band} \{ \begin{matrix}{M}_{snow , band} {SWE}_{band} \geq {M}_{snow , band} > 0 \\ {SWE}_{band} + [ {M}_{snow , band} - {SWE}_{band} ] \\ {DDF}_{ice} * ( {T}_{band} - {T}_{melt} ) {SWE}_{band} = 0\end{matrix} * \frac{{DDF}_{ice}}{{DDF}_{snow}}$$
$$0 < {SWE}_{band} < {M}_{snow , band ;}$$
wherein, M_{band} represents total snow and glacier melting water, DDF_{ice} is a glacier melting degree-day factor, SWE_{band} is snow water equivalent amount of the current glacier zone, M_{snow, band} is the potential snow melting amount, T_{band} is air temperature of the glacier zone, and Tₘₑₗₜ is a melting temperature of snow or glacier;
wherein a runoff depth of each of the glacier zones is equal to a sum of a rainfall amount and a total melting water of snow and ice; on scale of each of the grids, a runoff depth of a glacier area is equal to a sum of products of all glacier zone runoff generation amounts and an area ratio contained in the grid:
$${R}_{band , i} = {P}_{rain , band , i} + {M}_{band , i} ;$$
$${R}_{g l a c i e r} = {\sum }_{i = 1}^{n} {A}_{frac , i} * {R}_{b a n d , i} ;$$
wherein, i is a number of each of the glacier zones, n is a number of the glacier zones, R_{band,i} is a runoff depth of an i-th glacier zone, R_{glacier} is a runoff depth of the glacier area, P_{rain,band,i} is a rainfall amount of the i-th glacier zone, M_{band,i} is an ice and snow melting water amount of the i-th glacier zone, and A_{frac,i} is an area proportion of the i-th glacier zone in the grid.

5. The construction method for a modular coupled water-heat hydrological model of distributed cold regions according to claim 4, wherein the S6 adopts multi-layer soil structure to reflect a water-heat transmission process in soil, and dividing soil thickness is determined by an exponential stratification method; in each time step, a calculation process of the water-heat transmission process in a soil layer comprises:
S61, calculating hydrothermal parameters of soil based on current soil liquid water content, ice content and organic matter content, wherein the hydrothermal parameters comprise thermal conductivity, hydraulic conductivity, volumetric heat capacity and moisture flux;
S62, solving a heat transmission equation to obtain a temperature of each layer of soil;
S63, updating soil liquid water content and ice content, hydraulic conductivity and moisture flux based on a latest calculated soil temperature;
S64, solving a Richard equation of considering ice-water phase transition to obtain water content and ice content of each layer of soil;
S65, repeating S61-S64, until errors of soil temperature and soil moisture reach a convergence standard; and
S66, calculating a water infiltration process by a multi-layer Green-Ampt algorithm, and updating soil moisture and soil temperature.

6. The construction method for a modular coupled water-heat hydrological model of distributed cold regions according to claim 5, wherein the water-heat transmission process in the soil layer is calculated by a following formula:
for each layer of soil, calculating a change of soil temperature:
$${C}_{s} \frac{\partial T}{\partial t} - {L}_{f} {ρ}_{ice} \frac{\partial {θ}_{ice}}{\partial t} = \frac{\partial }{\partial z} [ {λ}_{s} \frac{\partial T}{\partial z} ] - {C}_{liq} \frac{\partial {q}_{l} T}{\partial z} ;$$
wherein, Cₛ is volumetric heat capacity of soil, λₛ is a thermal conductivity of the soil, ρ_{ice} is density of ice, θ_{ice} is a volumetric ice content, qₗ is a liquid moisture flux, C_{liq} is volumetric heat capacity of liquid water, T is a temperature of the soil, Z is a depth of the soil, and L_{f} is melting potential;
the volumetric heat capacity of the soil is expressed as a weighted sum of volumetric heat capacities of various components in the soil;
$${C}_{s} = ( 1 - organic ) * {ρ}_{b} * {c}_{m} + organic * {ρ}_{b} * {c}_{0} + {θ}_{liq} * {ρ}_{liq} * {c}_{liq} + {θ}_{ice} * {ρ}_{ice} * {c}_{ice} + {θ}_{air} * {ρ}_{air} * {c}_{air} ;$$
wherein, ρ_{b} is soil bulk density, cₘ is specific heat of minerals, cₒ is specific heat of organic matter, θₐᵢᵣ is volume fraction of air, θ_{liq} is a water content of liquid water (m³·m⁻³), and organic is volume fraction of the organic matter;
the thermal conductivity of the soil is obtained by combining dry state thermal conductivity and saturated state thermal conductivity weighted by Kersten number:
$${λ}_{s} = ( {λ}_{s a t} - {λ}_{d r y} ) * {K}_{e} + {λ}_{d r y} ;$$
wherein, Kₑ is a function of soil saturation and the volume fraction of the organic matter, λ_{dry} is soil dry state thermal conductivity, and λₛₐₜ is soil saturated state thermal conductivity;
$${K}_{e} = \{ \begin{matrix}{S}_{r}^{( 1 + organic - {av}_{sand} - {v}_{gravel} ) {\{ {[ \frac{1}{1 + {e}^{- β {s}_{r}}} ]}^{3} - {( \frac{1 - {S}_{r}}{2} )}^{3} \}}^{1 - organic} unfreezed soil} \\ {S}_{r}^{1 + organic} frozen soil\end{matrix} ;$$
wherein, Sᵣ is the soil saturation, v_{sand} is volume fraction of sand, v_{gravel} is volume fraction of gravel, and α and β are adjustment factors; a relationship between Kₑ and Sᵣ is used to predict a continuous change of thermal conductivity in a whole soil saturation level and particle size distribution range, enabling to be suitable for a calculation of thermal conductivity of permafrost in arid and semi-arid areas;
in cold areas, when soil temperature is higher than a freezing point, matrix potential is expressed as a function of liquid water content, and when temperature drops below the freezing point, the matrix potential drops rapidly, and is given by a freezing point water potential equation:
$$Ψ = \{ \begin{matrix}\frac{{L}_{f} \cdot T}{g * ( T + 273.15 )} T \leq {T}_{f} \\ {Ψ}_{e} * {( \frac{{θ}_{liq}}{{θ}_{sat}} )}^{- b} T > {T}_{f}\end{matrix} l$$
wherein, Ψ is soil matrix potential, b is Campbell pore size distribution index, T_{f} is the freezing point, θₛₐₜ is saturated water content, and g is gravity acceleration;
describing a moisture movement by using matrix potential gradient;
$${q}_{l} = {K}_{e f f} \cdot ( \frac{\partial Ψ}{\partial z} + 1 ) ;$$
wherein, K_{eff} is effective hydraulic conductivity;
when the soil begins to freeze, blocking effect of soil ice on moisture transmission is considered by introducing a blocking factor:
$${K}_{eff} = \{ \begin{matrix}{K}_{sat} * {( \frac{Ψ}{{Ψ}_{e}} )}^{( 2 + 3 / b )} {θ}_{ice} = 0 \\ {K}_{sat} * {( \frac{Ψ}{{Ψ}_{e}} )}^{( 2 + 3 / b )} * {10}^{- E * {m}_{ice}} {θ}_{ice} > 0\end{matrix} ;$$
$${m}_{ice} = \frac{{ρ}_{ice} * {θ}_{ice}}{{ρ}_{ice} * {θ}_{ice} + {ρ}_{liq} * {θ}_{liq}} ;$$
wherein, E is the blocking factor, and m_{ice} is a ratio of ice content to total water content;
assuming that the soil medium is incompressible, and water vapor migration is ignored, according to Darcy's law and mass conservation principle, obtaining a basic equation of soil moisture movement:
$$\frac{\partial {θ}_{l i q}}{\partial t} = \frac{\partial }{\partial z} [ {K}_{e f f} ( \frac{\partial Ψ}{\partial z} + 1 ) ] - \frac{{ρ}_{i c e}}{{ρ}_{l i q}} \frac{\partial {θ}_{i c e}}{\partial t} + S ;$$
wherein S is source sink term in the water flux.

7. The construction method for a modular coupled water-heat hydrological model of distributed cold regions according to claim 6, wherein S7 comprises:
S71, calculating surface runoff depth and underground runoff depth of each of the grids;
calculating the surface runoff by a following formula:
$${R}_{s u r} = max ( 0 , [ ( {P}_{rain} + {M}_{s n o w} ) - Infil - {Pond}_{max} ] * ( 1 - {glacier}_{f r a c} ) + {glacier}_{f r a c} * {R}_{glacier} ) ;$$
wherein, Pᵣₐᵢₙ is rainfall amount of the grid, Pondₘₐₓ is a maximum allowable water depth, Infil is a total accumulated water seepage amount, and glacier_{frac} is a proportion of glacier area in the grid;
underground runoff of an i-th layer soil is:
$${R}_{sub , i} = \{ \begin{matrix}( {θ}_{liq} - {θ}_{f} ) * Δ {z}_{i} / Δ t * {α}_{r} * Δ t & {θ}_{liq} > {θ}_{f} \\ 0 & {θ}_{liq} \leq {θ}_{f}\end{matrix} ;$$
wherein, θ_{f} is a field capacity, Δzᵢ is a thickness of the i-th layer soil, and αᵣ is an underground runoff factor;
a total underground runoff is a sum of R_{sub,i} of all soil layers above bedrock;
S72, calculating a confluence process:
based on a confluence file prepared the elevation data, driven by simulated output surface runoff depth and underground runoff depth, and calculating a process of slope surface confluence and river network confluence by a Lohmann confluence model, obtaining basin outlet runoff; and
building a relationship between annual average air temperature, annual average precipitation, permafrost coverage rate and frozen layer groundwater;
final runoff at basin outlet is a sum of output of the Lohmann confluence model and output of a freezing layer groundwater module, namely:
$${Q}_{total} = {Q}_{sur \_ sub} + {Q}_{s u b per} ;$$
wherein, Qₜₒₜₐi is the final runoff at the basin outlet, Q_{sur_sub} is basin outlet runoff output by the Lohmann confluence model, and Q_{subper} is the frozen layer groundwater.

8. The construction method for a modular coupled water-heat hydrological model of distributed cold regions according to claim 7, wherein the model evaluation indicators comprise a nash efficiency coefficient, a Kline-Gupta efficiency coefficient, percentage deviation, root mean square error and a determining coefficient.
